(19) United States
(12) Patent Application Publication
(10) Pub. No.: US 2025/0076630 A1
(43) Pub. Date: Mar. 6, 2025

(54) METHOD FOR GENERATING AN IMAGE OF A SAMPLE

(71) Applicant: Carl Zeiss Microscopy GmbH, Jena (DE)

(72) Inventors: Manuel Amthor, Jena (DE); Daniel Haase, Jena (DE); Joerg Siebenmorgen, Jena (DE)

(73) Assignee: Carl Zeiss Microscopy GmbH, Jena (DE)

(21) Appl. No.: 18/821,023

(22) Filed: Aug. 30, 2024

(30) Foreign Application Priority Data
Aug. 31, 2023 (DE) 10 2023 123 555.9

(51) Int. Cl. G02B 21/36; G02B 21/08; G06T 5/60

(52) U.S. Cl. CPC G02B 21/365; G02B 21/08; G06T 5/60; G06T 2207/10056; G06T 2207/10152; G06T 2207/20081

(57) ABSTRACT

A method for generating an image of a sample includes radiating a first grid-shaped light sheet of a first wavelength range onto the sample in such a way that the sample is inhomogeneously illuminated by the first light sheet, capturing the light emitted by the sample due to the radiating of the first light sheet of the first wavelength range onto the sample; and reconstructing first areas of the sample, which are not illuminated or are more weakly illuminated using the first light sheet of the first wavelength range, on the basis of the captured light of the second areas of the sample, which are more strongly illuminated using the light sheet of the first wavelength range, by means of a machine learning system.

### CROSS-REFERENCE TO RELATED APPLICATIONS

This application claims priority to German patent application 10 2023 123 555.9 filed on 31 Aug. 2023 , the entire content of which is incorporated herein by reference.

### BACKGROUND OF THE INVENTION

### Field of the Invention

The invention relates to a method for generating an image of a sample.

### DESCRIPTION OF RELATED ART

It is known that in light sheet microscopy (also called Gaussian light sheet microscopy), excitation light is irradiated perpendicular to the observation direction. A grid-shaped light sheet is irradiated onto a plane of the sample. First areas are not irradiated or are irradiated more weakly with light than second areas of the plane of the sample due to the grid shape. By means of a scanner (such as a movable mirror), the position or phase of the light sheet is changed by the so-called dithering method in such a way that the plane of the sample is homogeneously illuminated or irradiated. The various planes of the sample can be homogeneously illuminated or irradiated successively in this way and an image or overall image of the sample can be generated.

This has the disadvantage that the sample is irradiated intensively using the light or using high light power. Moreover, the scanning or irradiation of the respective plane of the sample takes a long time.

### SUMMARY OF THE INVENTION

The invention is based on the object of providing a method for generating an image of a sample, by which the sample is illuminated or irradiated weakly or with low light power and which can be carried out quickly.

This object is achieved by a method described herein.

### BRIEF DESCRIPTION OF THE DRAWINGS

Preferred embodiments result from the dependent embodiments. The invention will be explained in more detail hereinafter on the basis of a drawing of an exemplary embodiment, in which

FIG. 1 shows a schematic view of an embodiment of the device according to the invention for generating an image of a sample;

FIG. 2 shows a schematic sequence of an embodiment of the method according to the invention for generating an image of a sample;

FIG. 3 shows a schematic view of the irradiation of a region of the sample;

FIG. 4 shows a schematic view of the non-illuminated first areas and the more strongly illuminated second areas; and

FIG. 5 shows a perspective view of the non-illuminated first areas and the more strongly illuminated second areas.

### DETAILED DESCRIPTION OF THE INVENTION

In particular, the object is achieved by a method for generating an image of a sample, wherein the method comprises the following steps: radiating a first grid-shaped light sheet of a first wavelength range onto the sample in such a way that the sample is inhomogeneously illuminated by the first light sheet; capturing the light emitted from the sample due to the radiating of the first light sheet of the first wavelength range onto the sample; and reconstructing first areas of the sample, which are not illuminated or are illuminated more weakly using the first light sheet of the first wavelength range, on the basis of the captured light from the second areas of the sample, which are illuminated more strongly using the light sheet of the first wavelength range, by means of a machine learning system.

One advantage of this is that the method can be carried out quickly. Moreover, the light power which is emitted onto the sample is low, since the sample is not irradiated or illuminated uniformly or homogeneously.

Moreover, the invention is based on the object of disclosing a device for generating an image of a sample which radiates a low light power onto the sample and which can generate the image of the sample quickly.

This object is achieved by a device described herein.

In particular, the object is achieved by a device for generating an image of a sample, wherein the device comprises a radiation device for radiating a first grid-shaped light sheet of a first wavelength range onto the sample in such a way that the sample is inhomogeneously illuminated by the first light sheet, a capture device for capturing the light emitted from the sample due to the radiating of the first light sheet of the first wavelength range onto the sample; and a reconstruction device for reconstructing first areas of the sample, which are not illuminated or are more weakly illuminated using the first light sheet of the first wavelength range, on the basis of the captured light of the second areas of the sample, which are more strongly illuminated using the first light sheet of the first wavelength range, by means of a machine learning system.

This has the advantage that the light power which is radiated onto the sample to generate the image is low. Moreover, the device can generate the image of the sample quickly.

Furthermore, the invention is based on the object of disclosing a method for training a machine learning system, by means of which a machine learning system for reconstructing areas of a sample which are not illuminated or are weakly illuminated by a first grid-shaped light sheet can be trained in a technically simple and rapid manner.

This object is achieved by a method described herein.

In particular, the object is achieved by a method for training a machine learning system for reconstructing first areas of a sample, which are not illuminated or are more weakly illuminated using a first grid-shaped light sheet of a first wavelength range, on the basis of the captured light from second areas of the sample, which are more strongly illuminated using the first light sheet of the first wavelength range, wherein the method comprises the following steps: radiating a first grid-shaped light sheet of a first wavelength range onto the sample in such a way that the sample is inhomogeneously illuminated to generate a partial image of the sample; generating a complete image of the sample, in particular by substantially uniform illumination of the first areas and the second areas of the sample using a light sheet; and inputting the complete image and the partial image into the machine learning system to train the machine learning system to reconstruct the first areas of the sample.

One advantage of this is that the method does not require manual intervention or manual checking during the training of the machine learning system. The training or the method can be carried out in a self-supervised or unmonitored manner, since the actual image or complete image is actually generated or captured. A user therefore does not have to have experience with respect to the generation of the training data and/or the training. Moreover, the machine learning system or the model of the machine learning system can be trained individually on location by the respective user. If the sample is movable (such as living cells), a registration or alignment between the complete image and the partial image can additionally be performed. It is possible in this case to calculate or determine the complete image from at least two partial images (for example by averaging). It is therefore possible that the complete image and the partial image are not recorded individually, but jointly. For this purpose, multiple partial images can be recorded with offset phase and the complete image can be calculated therefrom (for example by averaging), instead of recording the complete image separately. However, it is also possible to record the complete image independently of the partial image.

In addition, the invention is based on the object of disclosing a further method for training a machine learning system, by means of which a machine learning system can be trained to reconstruct areas of a sample which are not illuminated or are weakly illuminated in a technically simple and rapid manner.

This object is achieved by a method described herein.

In particular, the object is achieved by a method for training a machine learning system for reconstructing first areas of a sample, which are not illuminated or are more weakly illuminated using a first grid-shaped light sheet of a first wavelength range, on the basis of the captured light from second areas of the sample, which are more strongly illuminated using the first light sheet of a first wavelength range, wherein the method comprises the following steps: providing one image and/or multiple images of the substantially homogeneously illuminated sample; combining the provided image and/or the provided images with a regular pattern, in particular a wave-shaped pattern, preferably a sinusoidal pattern or a sine pattern, to generate simulated first areas, which are not illuminated or are more weakly illuminated, to generate a simulated partial image of the sample; and inputting the provided image and/or the provided images and the simulated partial image into the machine learning system to train the machine learning system to reconstruct the first areas.

This has the advantage that the simulated partial image has the same gaps or omissions as an image in which the first areas of the sample are not illuminated or are more weakly illuminated (than the second areas). Moreover, the provided image or the provided images of the sample can have been recorded or created by means of a light sheet or also recorded or created in another manner. In addition, a large number of simulated partial images can be generated in a short time by this method, and so the machine learning system can be trained rapidly and efficiently.

Moreover, the invention is based on the object of disclosing a method for generating training data for training a machine learning system for reconstructing areas of a sample, which are not illuminated or are weakly illuminated by a first grid-shaped light sheet, which generates a large amount of training data in a technically simple and rapid manner.

This object is achieved by a method described herein.

In particular, the object is achieved by a method for generating training data for training a machine learning system to reconstruct first areas of a sample, which are not illuminated or are more weakly illuminated using a first grid-shaped light sheet of a first wavelength range, on the basis of the captured light from second areas of the sample, which are more strongly illuminated using the first light sheet of the first wavelength range, wherein the method comprises the following steps: providing a complete image of the sample, wherein, in the complete image of the sample, the first areas and the second areas of the sample are substantially homogeneously illuminated using a light sheet; providing a partial image, wherein, in the partial image, first areas of the sample are not illuminated or are more weakly illuminated using a first light sheet than second areas of the sample; generating a generative model on the basis of the complete image and the partial image, wherein the generative model generates a partial image from the complete image; and generating a partial image on the basis of a complete image using the generative model.

This has the advantage that a large amount of training data can be generated by this method within a short time. A radiation pattern is simulated by means of a grid-shaped light sheet by the method. The generated partial images are therefore very realistic. So-called hallucinations, which are otherwise undesirable, do not play a significant role here, since the generated partial image is not a measured image, rather only training data for training the machine learning system or the model of the machine learning system. In addition, the generative model can be technically simple, since it only has to generate the radiation pattern (generating first areas of the sample which are not illuminated or are more weakly illuminated), but does not have to carry out the reconstruction of these first areas. Therefore, a generic or generally valid generative model can be generated, since it does not have to be recreated or retrained for each type of sample. By means of the method, data or partial images can be generated from data, which were recorded in any arbitrary way (using a grid-shaped light sheet or for example using a laser scanning microscope), which correspond to an image which is generated using a grid-shaped light sheet (without dithering within a plane or with inhomogeneous irradiation of the planes). These partial images together with the respective complete image can then be used as training data for training the machine learning system. The generative model can in particular be generated by means of a generative adversarial network (GAN) or a conditional generative adversarial network (cGAN). An auto encoder network or auto encoder networks is or are also conceivable.

The invention is also based on the object of disclosing a further method for generating training data for training a machine learning system to reconstruct areas of a sample which are not illuminated or are weakly illuminated by a grid-shaped light sheet, which generates a large amount of training data in a technically simple and rapid manner.

This object is achieved by a method described herein.

In particular, the object is achieved by a method for generating training data for training a machine learning system to reconstruct first areas of a sample, which are not illuminated or are more weakly illuminated using a first grid-shaped light sheet of a first wavelength range, on the basis of the captured light from second areas of the sample which are more strongly illuminated using the first light sheet of the first wavelength range, wherein the method comprises the following steps: providing a complete image of the sample, wherein in the complete image of the sample, the first areas and the second areas of the sample are substantially homogeneously illuminated using a light sheet; providing a partial image, wherein in the partial image, first areas of the sample are not illuminated or are more weakly illuminated using the first light sheet than second areas of the sample; generating a generative model on the basis of the complete image and the partial image, wherein the generative model generates a partial image from the complete image; determining the parameters which generate a partial image from the complete image; providing a further complete image; changing the determined parameters in such a way that a partial image corresponding to the complete image can be generated by means of the determined parameters from a complete image; and generating a partial image corresponding to the further complete image on the basis of the parameters.

This has the advantage that a large amount of training data can be generated within a short time, and so the machine learning system can be trained rapidly. The complete images can be provided in this case in a subspace, in which those parameters which are responsible for generating the first areas of the sample, which are not illuminated or are more weakly illuminated, are ascertained and used for the generation of partial images. A data set can be generated from complete images and partial images. The complete images and the partial images do not have to correspond to one another. The generative model (such as SytleGAN) can be trained on the basis of these data. The parameters for generating the first areas which are not illuminated or are more weakly illuminated can be defined so that then any complete images can be projected into the parameter space, which are adapted for generating the first areas of the sample, which are not illuminated or are more weakly illuminated, in such a way that it corresponds to an image which corresponds to a grid- shaped light sheet (without dithering within a plane or with inhomogeneous illumination of the sample), then the image is back-projected again into the image space. An image pair made up of complete image and partial image thus results from each complete image. The generative model does not have to be or comprise a deep neural network, but rather can also comprise or be a classical model (e.g. PCA, NMS, GMM, etc.).

In addition, the invention is based on the object of disclosing a method for training a machine learning system for reconstructing parts of the sample, which is technically particularly simple.

This object is achieved by a method described herein.

In particular, the object is achieved by a method for training a machine learning system for reconstructing first areas of a sample, which are not illuminated or are illuminated more weakly using a first grid-shaped light sheet of a first wavelength range, on the basis of the captured light from second areas of the sample, which are illuminated more strongly using the first light sheet of the first wavelength range, wherein the method comprises the following steps: generating training data according to the above-described method; inputting the complete images and the generated partial images respectively corresponding thereto into a machine learning system to train the machine learning system for reconstruction.

One advantage of this is that the machine learning system is trained rapidly and efficiently. The partial images can be the input data or source data in this case and the complete images can be the target data. It is also conceivable that the complete images are the input data or source data and the partial images are the target data.

Moreover, the invention is based on the object of disclosing a machine learning system, which can reconstruct parts of the sample in a technically simple and rapid manner.

This object is achieved by a machine learning system described herein.

In particular, the object is achieved by a machine learning system which was trained by means of an above-described method.

This has the advantage that the machine learning system is trained very efficiently and reliably with respect to the reconstruction of the first areas of the sample, which are not illuminated or are more weakly illuminated by a grid-shaped light sheet.

Moreover, the above-mentioned object is achieved by a computer program product, which has instructions readable by a processor of a computer, which, when they are executed by the processor, prompt the processor to carry out the above-described method for training a machine learning system or for generating training data for training a machine learning system. The above-mentioned object is also achieved by a computer-readable medium on which the above-mentioned computer program product is stored.

According to one embodiment of the method for generating an image of a sample, the first areas of the sample, which are not illuminated or are more weakly illuminated using the light sheet of the first wavelength range, are in the same plane as the second areas of the sample, which are more strongly illuminated using the first wavelength range. The sample can be illuminated with particularly good distribution in this way. The structure of the sample can therefore be recognized particularly well and the second areas can be reconstructed particularly reliably. The plane can in particular be a plane which is irradiated using the light sheet without a shift between light sheet and sample.

According to one embodiment of the method for generating an image of a sample, at least one first plane exists, in which only first areas of the sample which are not illuminated or are more weakly illuminated using the first light sheet of the first wavelength range lie, and at least one second plane exists, in which only second areas of the sample, which are more strongly illuminated using the first light sheet of the first wavelength range, lie. In this way, it is possible that one plane of the sample is completely illuminated more strongly (for example by means of dithering within the plane or homogeneous illumination within the plane) and a further plane directly adjacent thereto and extending parallel is not illuminated or is illuminated more weakly.

According to one embodiment of the method for generating an image of a sample, the method furthermore comprises the following step: changing the phase and/or position of the first grid-shaped light sheet together with a shift of the sample relative to the first light sheet in such a way that the first areas of the sample of a first plane, which are not illuminated or are illuminated more weakly, are located offset to the first areas of a second plane of the sample, parallel to the first plane, which are not illuminated or are illuminated more weakly using the first wavelength range. This has the advantage that the first areas can each be arranged offset to the second areas. The first areas can therefore be offset to one another particularly finely, due to which fine structures can be recognized or reconstructed particularly well. The first areas can therefore be reconstructed particularly reliably.

According to one embodiment of the method for generating an image of a sample, in the step of reconstructing the first areas of a first plane of the sample, which are not illuminated or are illuminated more weakly, light captured from more strongly illuminated second areas of a second plane of the sample different from the first plane is taken into consideration. This has the advantage that a three-dimensional reconstruction is carried out. In this way, not only are properties of the sample within one plane taken into consideration, but rather planes of the sample (directly) adjacent to one another are taken into consideration in the reconstruction. It is also conceivable in this case that captured light from more strongly illuminated second areas from more than one (e.g. two, three, four, or more) plane of the sample different from the first plane is taken into consideration.

According to one embodiment of the method for generating an image of a sample, in the step of reconstructing the first areas, which are not illuminated or are illuminated more weakly, a transmitted light image of the sample is taken into consideration. Further items of information about the structure of the sample can be taken into consideration in the reconstruction by way of a transmitted light image of the sample. The reliability of the step of reconstructing increases in this way.

According to one embodiment of the method for generating an image of a sample, the method furthermore comprises the following steps: radiating a second grid-shaped light sheet of a second wavelength range, which is different from the first wavelength range, onto the sample in such a way that the first areas of the sample, which are not illuminated or are more weakly illuminated using the first wavelength range, are at least partially more strongly illuminated using the second light sheet of the second wavelength range than the second areas of the sample more strongly illuminated using the first light sheet of the first wavelength range; and capturing the light emitted from the sample due to the radiating of the second light sheet of the second wavelength range onto the sample, wherein the captured light of the second light sheet of the second wavelength range is taken into consideration in the step of reconstructing. This has the advantage that the two light sheets of different wavelength ranges or the items of information of the light emitted by the sample due to the illumination using the two light sheets can mutually supplement one another. Therefore, on the one hand the sample is only irradiated with low light power and, on the other hand, items of information from two wavelength ranges mutually supplement one another or the items of information of the two light sheets are complementary to one another. In this way, the first areas can be reconstructed particularly accurately or reliably. In particular, the second areas, which are illuminated or irradiated using the first light sheet, are essentially not irradiated or are irradiated more weakly using the second light sheet, and the first areas, which are not irradiated or are more weakly irradiated using the first light sheet, are illuminated or irradiated using the second light sheet. In this way, two partial images of the sample complementary to one another result. In this way, the sample is protected and possible bleaching by the first light sheet plays essentially no role in the recording of the sample using the second light sheet.

According to one embodiment of the method for generating an image of a sample, the method furthermore comprises the following steps: radiating a third grid-shaped light sheet onto the sample and changing the position and/or phase of the third light sheet in such a way that the sample is substantially homogeneously illuminated by the light sheet, and capturing the light emitted from the sample due to the radiating of the third light sheet onto the sample to form an image of the sample. In this way, at a point in time (possibly also after carrying out the experiment), a complete image of the sample or a plane of the sample can be recorded. The machine learning system can therefore be trained off-line or before or after the experiment and the reconstruction can thus be carried out actually after the experiment. This means that initially the partial images (having gaps in the first areas) can be recorded and then the image by means of the third light sheet. Only then is the model or the machine learning system trained and subsequently the reconstruction of the first areas which are not illuminated or are illuminated more weakly is carried out by means of the trained machine learning system. It is therefore possible that a high light power is not radiated onto the sample (e.g. living cells) until the experiment has actually ended.

According to one embodiment of the method for generating an image of a sample, the method furthermore comprises the following steps: determining a noise level of the second areas of the sample; and generating a noise in the reconstructed first areas of the sample, which are not illuminated or are illuminated more weakly using the first light sheet of the first wavelength range, on the basis of the determined noise level. This has the advantage that essentially no optical difference perceivable to the human eye exists between the reconstructed first areas and the captured second areas of the sample. The generated image therefore appears more real or more realistic, i.e. as if the first areas had actually been captured.

According to one embodiment of the method for generating an image of a sample, the shape and/or the position and/or the wavelength range of the first light sheet and/or the second light sheet is adapted to the sample. One advantage of this is that special features of the sample can be handled by the adaptation, and so the reconstruction is even more reliable or more accurate.

According to one embodiment of the method for generating an image of a sample, the first areas of the sample and the second areas of the sample are illuminated for different lengths of time by the first light sheet. This has the advantage that regions or areas of the sample which are of interest can be illuminated for longer and/or regions or areas which are sensitive to the light can be illuminated a shorter period of time. The respective conditions of the sample can therefore be handled specifically. The sample can thus be irradiated or illuminated in a particularly careful manner.

According to one embodiment of the method for generating an image of a sample, the steps of radiating the first grid-shaped light sheet of the first wavelength range onto the sample and capturing the light emitted in this way are each carried out at multiple different points in time, wherein the points in time are chronologically spaced apart from one another, in particular equidistantly, wherein at least one point in time is omitted in such a way that at the omitted point in time, the step of radiating the first grid-shaped light sheet is omitted, and wherein an image of the sample at the omitted point in time is reconstructed on the basis of the captured light at other points in time by means of a machine learning system. One advantage of this is that not only are specific areas irradiated more weakly or even not at all, but rather at at least one point in time the sample is not irradiated at all. This further reduces the radiant power or light power which acts on the sample. The sample or a part of the sample can therefore be partially irradiated in a fixed rhythm (first areas not irradiated or irradiated more weakly and second areas irradiated more strongly), while at one of the points in time the irradiation is omitted or is not carried out. The machine learning system can reconstruct an image of the sample at this omitted point in time from the captured data at other points in time.

A grid-shaped light sheet can be understood in particular as a thin (e.g. a few micrometers wide) light beam, which has illuminated or irradiated second areas and non-illuminated or non-irradiated first areas spaced apart from one another. This means that a non-illuminated first area lies between each two illuminated second areas and vice versa. The term “grid-shaped light sheet” can also be understood as a one-dimensional light sheet. In particular, the term “grid-shaped light sheet” can be understood as a one-dimensional strip pattern, which illuminates second areas of the sample and illuminates first areas of the sample more weakly (than the second samples) or does not illuminate them.

The light beam can in particular comprise a laser beam or be a laser beam.

The term “inhomogeneous” or “not homogeneous” can be understood in particular to mean that the light power per unit of area or per unit of volume is distributed unevenly or nonuniformly over the sample or a plane of the sample.

The term “non-illuminated area” can be understood in particular as an area or a region which is essentially not irradiated by the grid-shaped light sheet. Therefore, essentially no light is emitted from this area or this region.

The term “more weakly illuminated area” can be understood in particular as an area of the sample on which less light power is radiated than onto a “more strongly illuminated area” of the sample. The terms “weaker” or “stronger” can therefore relate to the light power or the light power per unit of area or unit of volume of the sample. For example, a “more weakly illuminated area” may be irradiated using a light power of approximately 10%, approximately 5%, or 1% of the light power of a “more strongly illuminated area”. If the first areas are not illuminated, the “more strongly illuminated areas” of the sample can be areas of the sample which are illuminated by the light sheet at all.

A transmitted light image can be understood in particular as an image which results from light or electromagnetic waves being emitted from a first side of the sample and emitted light or electromagnetic waves being captured on the first side and/or on the second side opposite to the first side. For example, an x-ray picture is a transmitted light image.

The term “reconstructing” can be understood in particular to mean that an image of at least a part of the sample or the structure or the construction of the first areas of the sample, which are not illuminated or are illuminated more weakly, is determined or calculated by means of the machine learning system. This means that (complete) measurement or capture of these first areas does not take place, but rather these first areas are determined or these first areas are concluded on the basis of captured or measured second areas. An overall image of the sample can be generated by means of the captured second areas and the reconstructed first areas or the reconstructed data of the first areas.

A “complete image” of a sample can be understood in particular as an image which contains or consists of actually captured image data of the sample. This means that a complete image does not comprise reconstructed data.

A “partial image” of a sample or a plane of the sample can be understood in particular to mean that in the partial image, specific areas of the sample or the plane are not illuminated or are illuminated more weakly using the light sheet than other areas of the sample. This means that the partial image represents an image of the sample in which the sample or a plane of the sample is not homogeneously and uniformly illuminated or irradiated using the light sheet, but rather specific areas have to be reconstructed in order to obtain an overall image of the sample or plane.

The “first wavelength range” and/or the “second wavelength range” can be very small. This means that the light sheet can also have only one frequency of light. The light sheet can comprise or be visible and/or in visible light or the light sheet can comprise or be electromagnetic waves of any type.

A fundamental concept of the present invention is that in light sheet microscopy, the sample is inhomogeneously irradiated or illuminated and the areas of the sample which are not illuminated or are more weakly illuminated are reconstructed by means of a machine learning system. The principle of compressed sensing is therefore applied.

In the following description, the same reference numerals are used for identical and identically acting parts.

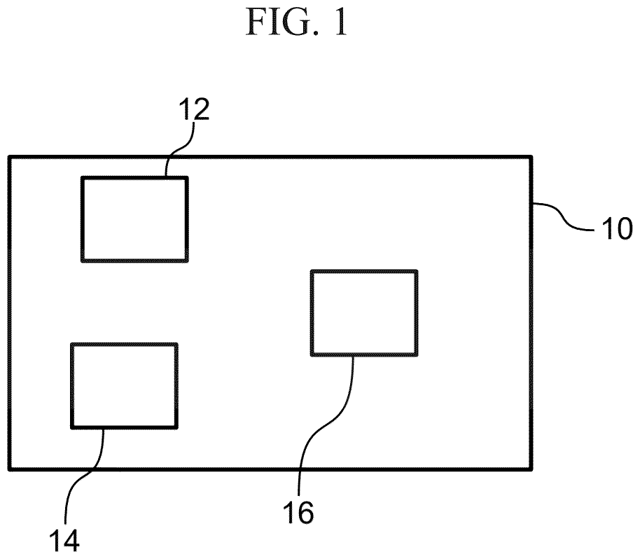

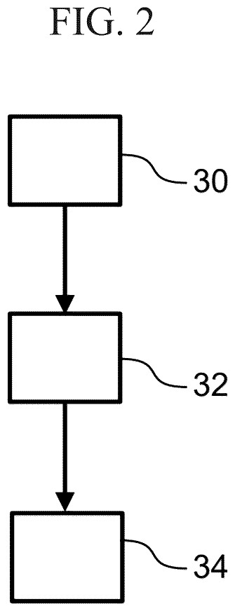

FIG. 1 shows a schematic view of an embodiment of the device 10 according to the invention for generating an image of a sample 45. FIG. 2 shows a schematic sequence of an embodiment of the method according to the invention for generating an image of a sample 45.

The device 10 for generating an image of a sample 45 comprises a beam device 12 for radiating a first grid-shaped light sheet of a first wavelength range onto the sample 45 in such a way that the sample 45 is inhomogeneously illuminated by the light sheet. Moreover, the device 10 has a capture device 14 for capturing the light emitted by the sample 45 due to the radiating of the light sheet of the first wavelength range on the sample 45. The device 10 moreover comprises a reconstruction device 16 for reconstructing first areas 60-65 of the sample 45, which are not illuminated or are more weakly illuminated using the light sheet of the first wavelength range, on the basis of the captured light of the second areas 66-71 of the sample 45, which are more strongly illuminated using the first wavelength range, by means of a machine learning system 16. The machine learning system 16 can be executed on a computer. Ultimately, an image of the sample is reconstructed or the gaps in the sample which were not illuminated or were only weakly illuminated, are calculated or estimated by means of the machine learning system.

In light sheet microscopy, a thin light beam or a light sheet is radiated onto a part of the sample 45 and the light 50 emitted essentially perpendicular to this input beam 40 by the sample 45 or the irradiated part of the sample 45 is captured.

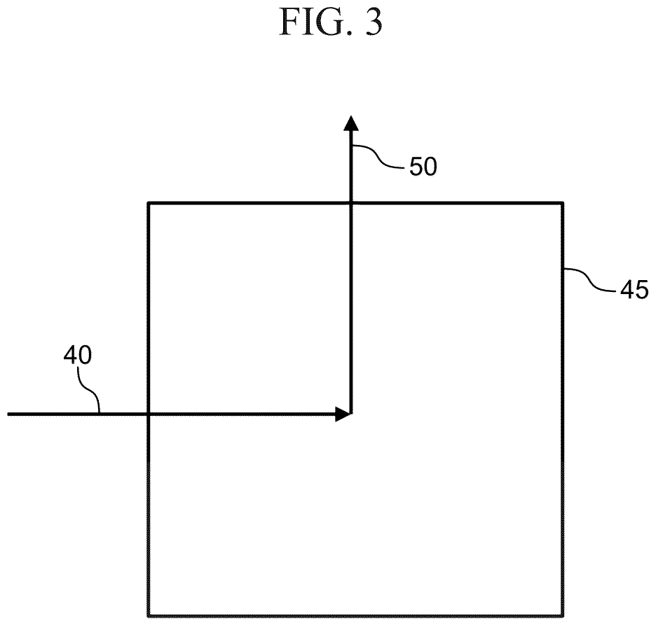

FIG. 3 shows a schematic view of the irradiation of a region of the sample 45. An input light beam illuminates a part of the sample 45 and output light is emitted by the part of the sample 45 and is captured at an angle of approximately 90° relative to the input light beam. The light sheet is grid-shaped, i.e. the light sheet has not illuminated first areas 60-65 or (in comparison to the more strongly illuminated areas) first areas which are illuminated more weakly (no light or only a small amount of light of the light sheet is radiated onto these areas) and more strongly illuminated second areas 66-71 (a large amount of light, in comparison to the first areas 60-65, is radiated onto these areas). Due to the grid shape of the light sheet, one first area 60-65, which is not illuminated or irradiated, lies between each two (more strongly) illuminated second areas 66-71. That is to say, first areas 60-65 and second areas 66-71 alternate in each case.

The light which is from the part of the sample 45 onto which the light beam or the light sheet is directed is captured by the capture device 14. Therefore, only a partial image of the sample 45 or of the plane 75 of the sample 45 is captured, since the first areas 60-65 emit no light or only a small amount of light which is captured.

In the methods known from the prior art, in which the sample 45 is irradiated using a grid-shaped light sheet, so-called dithering is carried out, i.e. scanning through the sample 45 or a plane 75 of the sample 45. For example, a spatial light modulator (SLM) generates a grid-shaped light sheet. The light sheet (during the exposure time of the camera) is shifted by at least one period by means of a scanning mirror. The grid structure of the light sheet is blurred by the integration of the camera and in this way a homogeneous illumination of the sample is achieved. This is however not carried out in the present invention, i.e. the sample 45 or the plane 75 of the sample 45 is not homogeneously illuminated, but rather inhomogeneously illuminated or irradiated.

For example, in each plane 75 irradiated by the light sheet, non-illuminated (first) areas 60-65 are present, since the light sheet is grid-shaped. These non-illuminated areas 60-65 can be reconstructed or determined by means of a machine learning system 16. For this purpose, the illuminated or more strongly illuminated second areas 66-71 or one image or multiple images of the illuminated (second) areas 66-71 are input into a machine learning system 16. The machine learning system 16 is trained to determine or to reconstruct the non-illuminated (first) areas 60-65 of the sample 45. The items of information from the illuminated second areas 66-71 of the sample 45 are used for this purpose. Structures or shapes of the sample 45 typically extend over a part of the sample 45 which lies partially in one or more illuminated second areas 66-71 and partially in non-illuminated or more weakly illuminated first areas 60-65 of the sample 45. The structure or shape of the sample 45 in the non-illuminated (first) areas 60-65 of the sample 45 can therefore be concluded by means of the machine learning system 16 on the basis of the captured light.

It is conceivable that the position or the phase of the light sheet is changed together with a relative movement between light sheet and sample 45. For example, the position or the phase of the light sheet can be changed from plane to plane in such a way that the illuminated areas 66-71 and non-illuminated areas 60-65 are each arranged offset in relation to one another.

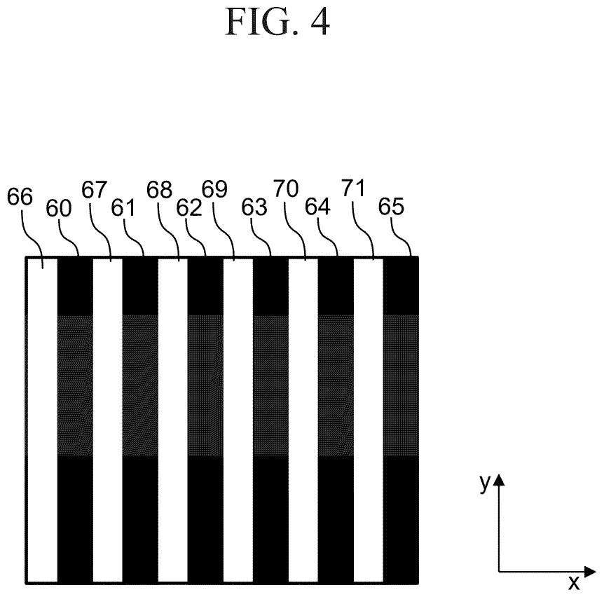

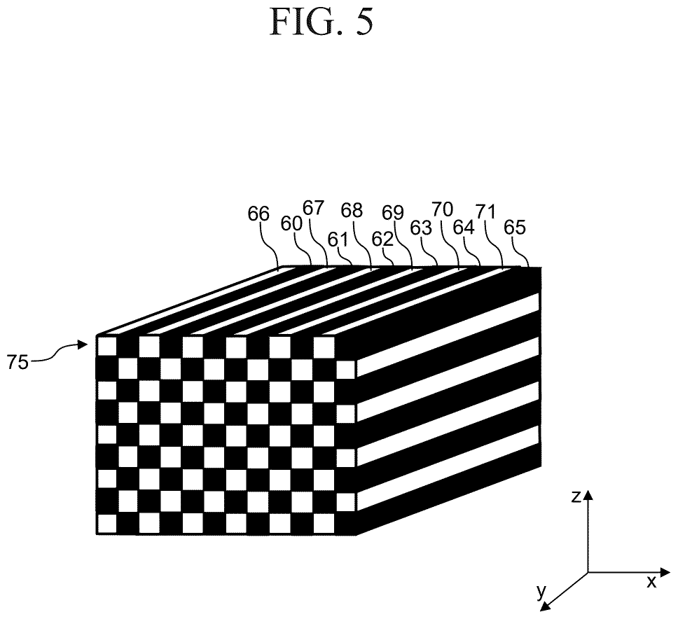

FIG. 4 shows a schematic view of the non-illuminated first areas 60-65 and the more strongly illuminated second areas 66-71, wherein the illuminated and non-illuminated areas of directly adjacent planes are each offset in relation to one another. Only one plane of the sample is visible in FIG. 4. FIG. 5 shows a perspective view of the non-illuminated first areas 60-65 and the more strongly illuminated second areas 66-71, wherein the illuminated second areas 66-71 are each offset in relation to the non-illuminated first areas 60-65 of the sample 45.

In FIG. 4 and in FIG. 5, the light sheet lies in each case in the x/y plane and propagates in the y direction. FIG. 4 shows a view along an x/y plane of the sample. The light emitted by the sample or by the illuminated areas is captured in the z direction.

In FIG. 4 and in FIG. 5, upon each shift of the light sheet relative to the sample 45 (to irradiate a new plane), the phase or position of the light sheet is changed so that non-illuminated (or more weakly illuminated) first areas 60-65 of a first plane 75 are directly adjacent to more strongly illuminated second areas 66-71 of the sample 45 in the next plane. In a side view of the x/z plane, a type of regular chessboard pattern therefore results at non- illuminated (first) areas 60-65 of the sample 45 (shown black in FIG. 4 and in FIG. 5) and more strongly illuminated (second) areas 66-71 of the sample 45 (shown in FIG. 4 and in FIG. 5). The illuminated second areas 66-71 and the non-illuminated or more weakly illuminated first areas 60-65 of the sample 45 are each equal in size. The distance by which the light sheet is offset relative to the sample 45 corresponds in FIG. 4 and in FIG. 5 precisely to the size of the first area 60-65 or the second area 66-71. However, the sizes can each be different.

The respective illuminated second areas 66-71 of the sample 45 extend in the plane of the drawing of FIG. 4. This means that the light sheet irradiates a larger region in each case along the y plane of the sample 45. The same applies with respect to the non-illuminated first areas 60-65.

In the reconstruction, the structure or shape of the sample 45 in the non-illuminated first areas 60-65 is determined or reconstructed on the foundation or on the basis of the illuminated second areas 66-71 of the sample 45 or at least a part of the illuminated second areas 66-71 of the sample 45 by means of the machine learning system 16.

The machine learning system 16 can preferably have an image-to-image model. This means that an input image is mapped on an output image by image regression. For this purpose, multiple planes of a sample 45 or the captured light from multiple planes of the sample 45 can be input into the machine learning system 16.

For the image-to-image model, for example encoder-decoder networks, which are typically implemented as a convolutional neural network (CNN) are used (e.g. U-Net, DevonNet, etc.). Networks having isotropic resolution are also possible, i.e. networks in which the resolution of the feature maps of each layer remains (nearly) equal with progressing depth of the network (for example, Super-Resolution Convolutional Neural Network; abbreviation: SRCNN). In addition, (vision) transformer models and/or diffusion models are also conceivable.

The machine learning system 16 or the model of the machine learning system 16 can be trained as a conditional generative adversarial network (cGAN), in order to achieve a realistic image impression. In addition to the pure prediction accuracy of the image transformation model, a discriminator model, which assesses the image impression, is also optimized in this case.

The machine learning system 16 or the model of the machine learning system 16 can be a 3D model. This means that input images or input image stacks have three spatial dimensions or extend in three dimensions. Images from multiple planes are therefore input into the machine learning system 16. Intermediate layers of the model or the machine learning system 16 can also have a three-dimensional structure, for example by way of 3D convolution operations. Items of information from different planes of the sample 45 extending parallel to one another are therefore taken into consideration in the reconstruction by means of the machine learning system 16.

However, it is also conceivable that the machine learning system 16 or the model of the machine learning system 16 is or implements or applies a two-dimensional model. In this case, the model only operates on a single plane 75 of the sample 45 or only uses items of information from one plane 75 of the sample 45 (wherein the plane extends in the x-y direction). Items of information from other planes are not used in this case. The plane 75 used typically extends along the direction in which the light sheet is emitted (x direction) and along the width of the light sheet (y direction). FIG. 4 shows the x-z plane.

For each position in the sample 45, in the model mapping is performed from a two-dimensional plane having static g grid-shaped light sheet onto a two-dimensional plane having grid-shaped light sheet with dithering, i.e. onto a two-dimensional plane in which the first areas 60-65 are reconstructed.

A further possibility is that items of information from a single plane are used, however this plane extends perpendicular to the above-described plane (x-y direction). That is to say, only items of information from multiple planes which are irradiated by means of a relative movement between sample 45 and light sheet are used. For example, only items of information from the x-z plane shown in FIG. 4 are used in each case for the reconstruction. It is however also conceivable that only items of information from the y-z plane are used in each case for the reconstruction. The advantage of this is that the gap size between (more strongly) second illuminated areas 66-71 and first areas 60-65 which are not illuminated or are more weakly illuminated can be particularly small. The gap size, i.e. the size of the first areas 60-65 which are not illuminated or are more weakly illuminated, would then correspond, for example, by the dimension by which the light sheet is moved in each case relative to the sample 45 (in order to illuminate or irradiate the next plane of the sample 45).

The size of the input image detail which is responsible for the decision of an output pixel (receptive field of the model) can be defined as desired. In this case, a compromise can be selected between a large value in order to obtain sufficient items of information about the structure of the sample 45 in order to be able to reconstruct the missing (first) areas 60-65 of the sample 45 and a small value in order to prevent unnecessary overfitting of the model to the training data. For example, the receptive field can be a multiple (1 to N) of the grid period and/or scanning period. The scanning period corresponds to the value by which the light sheet is moved relative to the sample 45 (in the z direction), so that the next plane can be illuminated using the light sheet. The grid period (which extends in the x direction) corresponds to the size of the respective first area 60-65 or the respective second area 66-71. Since the scanning period (in the z direction) and the grid period (depending on the structure of the light sheet) are typically of different sizes, it is conceivable that the receptive field is formed differently in each spatial direction. This can be achieved, for example, in the case of a CNN by different filter sizes, subsampling step width, etc.

Alternatively, a three-dimensional image stack can be generated by the travel along the sample 45 or by the movement of the sample 45 relative to the light sheet. For this purpose, the (static) light sheet can illuminate the sample 45 at alternating (defined) positions at each point in time during the traverse. The reconstruction then takes place in three dimensions, i.e. items of structure information from the adjacent surroundings (lateral surroundings) and also from adjacent layers or planes are used for the reconstruction. The layers and/or planes can run in the x-z direction or the y-z direction.

Alternatively, it is possible to not change the position of the scanned light sheet or the position of the first areas 60-65 and the second areas 66-71 of the respective plane 75 during the movement of the sample 45 relative to the light sheet in the z direction (so-called traversing of the sample 45). In this case, the first areas 60-65 of a first plane 75 are not offset to the first areas of a plane parallel to the first plane 75, but rather in each case only first areas 60-65 or only second areas 66-71 are located along a plane (which comprises the y axis and the z axis). This can be expedient if the position of the light sheet relative to the sample 45 cannot be changed or can be changed only to a restricted extent for technical reasons. Nonetheless, a two-dimensional or three-dimensional reconstruction by means of the machine learning system 16 is possible.

It is conceivable that the first areas 60-65 are illuminated more weakly (but are not non-illuminated) than the second areas 66-71 using the light sheet. A type of intermediate state of the illumination can thus be created in which the grid-shaped light sheet is not (fully) static, but the light sheet is at least partially moved (per layer or plane 75 of the sample 45), but the sample 45 or the plane 75 of the sample 45 is illuminated inhomogeneously. It is thus possible that the second more strongly illuminated areas 66-71 are illuminated using 100% of the light power (wherein 100% corresponds to an arbitrary absolute value), while the more weakly illuminated areas 60-65 are only illuminated with approximately 10% to approximately 20%, for example 15%, or approximately 5% to approximately 10% or approximately 1% of the light power. The more weakly illuminated second areas 66-71 therefore have to be at least partially reconstructed by means of the machine learning system 16. It is moreover possible that the first areas 60-65 and the second areas 66-71 of the sample 45 are illuminated using the light sheet for different lengths of time. Multiple positions of the light sheet within a plane 75 of the sample 45 are also possible, wherein the captured light is then summed.

In addition to the first light sheet of the first wavelength range, a second light sheet of a second wavelength range can be radiated onto the sample 45. It is possible that the first light sheet and the second light sheet have phases or positions inverse to one another. The areas 66-71 illuminated more strongly using the first light sheet can therefore not be illuminated or illuminated more weakly using the second light sheet and the areas 60-65 not illuminated or illuminated more weakly using the first light sheet can be illuminated more strongly using the second light sheet. In this way, the sample 45 is illuminated or irradiated inhomogeneously and different or complementary items of information are captured from each position or each area of the sample 45. In this way, the reconstruction can be carried out particularly precisely or reliably on the basis of the captured light from the first light sheet and on the basis of the captured light from the second light sheet. The first wavelength range can be disjointed from the second wavelength range. However, it is also conceivable that there is an overlap between the first wavelength range and the second wavelength range. It is also conceivable that further light sheets having further wavelength ranges are used.

It is also conceivable that a first plane 75 is only illuminated using the first light sheet and a second plane, which is parallel to the first plane 75 and is directly adjacent to the first plane 75, is only illuminated using the second light sheet. It is possible that planes which are only illuminated using the first light beam and planes which are only illuminated using the second light beam each alternate.

Moreover, a transmitted light image of the sample 45 can be input into the machine learning system 16 in order to improve the reconstruction of the first areas 60-65 or the overall image. For example, the transmitted light image can be an x-ray image of the sample 45. It is also possible that in addition to the fluorescent contrast image generated by the light sheet, a nonfluorescent contrast image, e.g., a phase contrast image, a differential interference contrast image or DIC contrast image, a bright-field contrast image, and/or a dark-field contrast image, of the sample is input into the machine learning system 16.

It is possible that at the beginning (for example of an experiment or during the exploration of a sample 45), the machine learning system 16 is not yet trained. In this case, first the previously known typical mode having grid-shaped light sheet, the phase or position of which within a plane 75 is changed, can be used in order to illuminate the sample 45 substantially homogeneously. This means that initially no areas of the sample 45 are reconstructed or have to be reconstructed. During the capturing and processing of the light in this mode, the model or the machine learning system 16 can be trained by means of the captured data or the captured light. The machine learning system 16 is trained on the fly.

The image pairs necessary for the training can be generated by generating images, in which there are first areas 60-65 which are not illuminated or are more weakly illuminated and second areas 66-71 which are more strongly illuminated, from recordings in which the sample 45 or a plane 75 of the sample 45 was illuminated substantially homogeneously, since the images in which the sample 45 was illuminated homogeneously correspond in principle at different positions to averaging of a large number of images in which there are first areas 60-65 which are not illuminated or are more weakly illuminated and second areas 66-71 which are more strongly illuminated. The reconstruction of areas of the sample 45 that preserves the sample 45 is therefore automatically available or retrievable after some time, after a sufficient amount of data has been captured and the machine learning system 16 has been trained in the background.

A further possibility is that, during a long-term experiment or an observation of a sample 45 over a longer period of time (e.g. several hours, several days, several weeks, or several months), the training data for training the machine learning system 16 are recorded during the experiment. The sample 45 or light from the sample 45 due to the radiating of a light sheet onto the sample 45 is captured at multiple, generally equidistant, time intervals. At specific points in time (e.g. the chronologically first recording, the chronologically last recording, or the recordings at points in time which are at regular intervals in relation to one another, or only at points of time of interest with respect to the sample 45), the method known from the prior art for the homogeneous illumination of the sample 45 by means of a grid-shaped light sheet is carried out, i.e. dithering is carried out (within a plane 75). At the other points in time, the sample 45 is illuminated or irradiated using a static light sheet (without dithering), such that first areas 60-65 are illuminated more weakly or are not illuminated, and second areas 66-71 are illuminated more strongly. The machine learning system 16 can be trained retrospectively in this case, i.e. after carrying out the experiment or after the observation period of time, by means of the captured data and all of the data or the first areas 60-65 at the other points in time can be reconstructed off-line. The recording of the training data using homogeneously illuminated sample 45 can be carried out in this case not until after the experiment or the observation (so-called last recording), since this is particularly gentle for the sample and has the least influence on the experiment, because the sample 45 is not (homogeneously) irradiated using the full light power until after the experiment. After the experiment, the machine learning system 16 can be trained to reconstruct the first areas 60-65 of the sample 45, which are not illuminated or are illuminated more weakly, at the different points in time from the partial images (by means of grid-shaped light sheet without dithering) and full images (by means of grid-shaped light sheet with dithering).

In the reconstructed first areas 60-65 of the sample 45, in the first instance the (random) noise is suppressed in the image reconstruction or the reconstruction of the first areas 60-65 by means of the machine learning system 16 on the basis of image-to-image models, since the noise present in normal or completely captured images of the sample 45 cannot be predicted for the reconstructed first areas 60-65. Therefore, the machine learning system 16 would also be trained for noise removal or the machine learning system 16 would have implicitly also learned noise removal by direct and full mapping (i.e. each pixel in the reconstructed image is determined by the machine learning system 16) of source image (or input image) onto target image (the output image). If this is not desired, it is possible for the more strongly illuminated second areas 66-71 to remain untouched by the machine learning system 16 or by the model of the machine learning system 16 and only the first areas 60-65 of the sample 45, which are not illuminated or are illuminated more weakly, to be reconstructed by the machine learning system 16. In this case, there is however an inhomogeneous image impression, since a noise is visible in the captured second areas 66-71, while no noise is present in the reconstructed first areas 60-65.

A homogeneous image impression can now be restored by determining the noise level of the second areas 66-71 After reconstructing the first areas 60-65, a corresponding noise is then subsequently artificially added to the reconstructed first areas 60-65, such that the noise level and/or the noise distribution or the noise characteristic of the second areas 66-71 essentially corresponds to the noise level and/or the noise distribution or the noise characteristic of the first areas 60-65.

A generation of the complete image of the sample can also be carried out as a linear combination in summary according to the following formula:

α* second areas+β* (first areas+noise)

wherein

α and β are locally variable and are constructed on the basis of the known grid geometry of the light sheet or are determined on the basis of the intensity of the output image. The noise or the noise parameters can also be locally variable.

It is also conceivable that a first plane 75 is dithered or is illuminated homogeneously by the light sheet and a second plane, which is directly adjacent to the first plane 75 and is parallel to the first plane 75, is not illuminated or irradiated by the light sheet. A third plane, which is directly adjacent to the second plane but is spaced apart from the first plane 75, is again homogeneously illuminated. That is to say, a homogeneously illuminated plane always alternates with a non-illuminated plane of the sample 45. The first (non-illuminated) areas 60-65 therefore always lie in a different plane than in the plane in which the second (illuminated) areas 66-71 lie. The machine learning system 16 in this case reconstructs the respective second plane, which was not illuminated,. The respective second plane therefore only consists of first areas 60-65.

Items of context information can be used in the step of reconstruction 34. This means that items of context information can be provided to the machine learning system 16. The items of context information can comprise, for example, items of information about the type of the experiment or the type of the sample 45, the user ID, the pigments used, with which the sample 45 has been marked, etc. The items of context information can be input into the model as an input, for example as a continuous numeric value (in particular in CNNs) or as a discretized “token” or by any other type of embedding in a vector space (in particular in the case of transformer networks).

It is also conceivable that an (automatic) selection of a suitable or already trained model of the machine learning system 16 is carried out. This already trained model can either be used without further training or the already trained model serves as the basis or starting point for further training of the model or the machine learning system 16 on the basis of the existing data or images.

In addition, it is possible that a device is present which checks (automatically) whether the respective model is still suitable for the reconstruction or whether the model has to be retrained. In the latter case, the device can output a warning or initiate retraining of the model.

A further possibility is that the light sheet or the structure or grid shape of the light sheet is adapted to the respective sample 45 and/or to the respective experiment. Thus, for example the illumination pattern or grid pattern can be adapted manually or automatically to the sample 45 (once or on-the-fly). The adaptation can be carried out on the basis of already recorded data or images. It is also possible that an improved illumination pattern is determined or learned by means of the machine learning system 16. This can take place, for example, by way of back propagation in the machine learning system 16.

So-called deskewing (transformation into an axially parallel view) can be carried out before or after the reconstruction.

It is possible that deconvolution, noise removal, and/or an increase of the resolution are carried out simultaneously. This can be implicitly achieved, on the one hand, by improved reconstruction. Alternatively or additionally, noise removal and/or deconvolution and/or increase of the resolution can be carried out before or after the step of reconstruction 34.

A further possibility is that after multiple planes of the sample 45 having gaps (first areas 60-65) have been captured (so-called first stacks) and while the reconstruction of the first areas 60-65 is being carried out, at least one further stack of planes of the sample 45 is captured, wherein the phases of the light sheet or the light sheets are shifted in this case in relation to the first stack in such a way that now the corresponding second areas are not illuminated or are illuminated more weakly and the corresponding first areas are now illuminated more strongly. In this way, missing data can be added. This means that the reconstruction by means of the machine learning system 16 is used as a type of quick preview, while complete data are recorded or captured and processed in the background (by homogeneous illumination of the sample 45), such that a complete image is present and can be displayed (without reconstruction of first areas 60-65 of the sample 45 which are not illuminated or are illuminated more weakly).

The method is suitable in particular for the observation or capture of living cells as sample 45, so-called living cell imaging. In this case, cells are irradiated or illuminated again and again for a longer period of time, e.g. for hours, for days, or for weeks, in order to generate an image. The phototoxicity can be kept low by the lower laser power which is necessary for the method. Alternatively, at laser power of the same magnitude, the integration time can be reduced and therefore processes in the cells can be captured with higher time resolution (for example time resolution which is twice as high).

### LIST OF REFERENCE SIGNS

10 device
12 beam device for radiating a light sheet
14 capture device
16 reconstruction device/machine learning system
30 step of radiating a light sheet
32 step of capturing the light
34 step of reconstructing areas of the sample
40 input beam
45 sample
50 emitted light
60-65 first areas of the sample
66-71 second areas of the sample
75 plane of the sample

1. A method for generating an image of a sample, wherein the method comprises:
radiating a first grid-shaped light sheet of a first wavelength range onto the sample in such a way that the sample is inhomogeneously illuminated by the first light sheet;
capturing light emitted from the sample due to the radiating of the first light sheet of the first wavelength range onto the sample; and
reconstructing first areas of the sample, which are not illuminated or are more weakly illuminated using the first light sheet of the first wavelength range, on the basis of light captured from the second areas of the sample, which are more strongly illuminated using the light sheet of the first wavelength range, by means of a machine learning system.

2. The method as claimed in claim 1, wherein the first areas of the sample, which are not illuminated or are more weakly illuminated using the light sheet of the first wavelength range, lie in the same plane as the second areas of the sample, which are more strongly illuminated using the first wavelength range.

3. The method as claimed in claim 1, wherein at least one first plane exists, wherein first areas of the sample, which are not illuminated or are more weakly illuminated using the first light sheet of the first wavelength range, lie, and
at least one second plane exists, in which only second areas of the sample, which are more strongly illuminated using the first light sheet of the first wavelength range, lie.

4. The method as claimed in claim 1, wherein the method further comprises:
changing a phase and/or a position of the first grid-shaped light sheet together with a shift of the sample relative to the first light sheet in such a way that the first areas of the sample of a first plane, which are not illuminated or are more weakly illuminated, lie offset to the first areas of a second plane of the sample parallel to the first plane, which are not illuminated or are more weakly illuminated using the first wavelength range.

5. The method as claimed in claim 1, wherein in reconstructing the first areas of a first plane of the sample, which are not illuminated or are illuminated more weakly, light captured from more strongly illuminated second areas of a second plane of the sample, which is different from the first plane, is taken into consideration.

6. The method as claimed in claim 1, wherein in reconstructing the first areas, which are not illuminated or are illuminated more weakly, a transmitted light image of the sample is taken into consideration.

7. The method as claimed in claim 1, wherein the method further comprises:
radiating a second grid-shaped light sheet of a second wavelength range, which is different from the first wavelength range, onto the sample in such a way that the first areas of the sample, which are not illuminated or are more weakly illuminated using the first wavelength range, are at least partially more strongly illuminated using the second light sheet of the second wavelength range than the second areas of the sample more strongly illuminated using the first light sheet of the first wavelength range; and
capturing light emitted by the sample due to the radiating of the second light sheet of the second wavelength range onto the sample, wherein in reconstructing, the captured light of the second light sheet of the second wavelength range is taken into consideration.

8. The method as claimed in claim 1, wherein the method further comprises:
radiating a third grid-shaped light sheet onto the sample and changing a position and/or a phase of the third light sheet in such a way that the sample is substantially homogeneously illuminated by the light sheet, and
capturing light emitted by the sample due to the radiating of the third light sheet onto the sample to form an image of the sample.

9. The method as claimed in claim 1, wherein the method further comprises:
determining a noise level of the second areas of the sample; and
generating a noise in the reconstructed first areas of the sample, which are not illuminated or are more weakly illuminated using the first light sheet of the first wavelength range, on the basis of the determined noise level.

10. The method as claimed in claim 1, wherein a shape and/or a position and/or a wavelength range of the first light sheet and/or the second light sheet is adapted to the sample.

11. The method as claimed in claim 1, wherein the first areas of the sample and the second areas of the sample are illuminated for different lengths of time by the first light sheet.

12. The method as claimed in claim 1, wherein radiating the first grid-shaped light sheet of the first wavelength range onto the sample and capturing the light emitted in this way are each carried out at multiple different points in time,
wherein the points in time are chronologically spaced apart from one another, in particular equidistantly,
wherein at least one point in time is omitted in such a way that at the omitted point in time, radiating the first grid-shaped light sheet is omitted, and
wherein an image of the sample at the omitted point in time is reconstructed on the basis of light captured at other points in time by a machine learning system.

13. The method as claimed in claim 1, wherein the first areas which are more weakly illuminated are not non-illuminated.

14. A device for generating an image of a sample, comprising:
a beam device for radiating a first grid-shaped light sheet of a first wavelength range onto the sample in such a way that the sample is inhomogeneously illuminated by the first light sheet,
a capture device for capturing light emitted by the sample due to the radiating of the first light sheet of the first wavelength range onto the sample; and
a reconstruction device for reconstructing first areas of the sample, which are not illuminated or are illuminated more weakly using the first light sheet of the first wavelength range, on the basis of light captured from the second areas of the sample, which are more strongly illuminated using the first light sheet of the first wavelength range, by means of a machine learning system.

15. The device according to claim 14, wherein the first areas which are illuminated more weakly are not non-illuminated.

16. A method for training a machine learning system for reconstructing first areas of a sample, which are not illuminated or are illuminated more weakly using a first grid-shaped light sheet of a first wavelength range, on the basis of light captured from second areas of the sample, which are more strongly illuminated using the first light sheet of the first wavelength range, wherein the method comprises:
radiating a first grid-shaped light sheet of a first wavelength range onto the sample in such a way that the sample is inhomogeneously illuminated in order to generate a partial image of the sample;
generating a complete image of the sample; and
inputting the complete image and the partial image into the machine learning system to train the machine learning system to reconstruct the first areas of the sample.

17. The method according to claim 16, wherein the first areas which are illuminated more weakly are not non-illuminated.

18. A method for training a machine learning system for reconstructing first areas of a sample, which are not illuminated or are illuminated more weakly using a first grid-shaped light sheet of a first wavelength range, on the basis of light captured from second areas of the sample, which are more strongly illuminated using the first light sheet of the first wavelength range, wherein the method comprises:
generating training data according to the method as claimed in claim 16; and
inputting the complete images and the generated partial images respectively corresponding thereto into a machine learning system to train the machine learning system for reconstruction.

19. The method according to claim 18, wherein the first areas which are illuminated more weakly are not non-illuminated.

20. A machine learning system, which was trained by means of the method as claimed in claim 16.

21. A computer program product, comprising:
instructions readable by a processor of a computer which, when they are executed by the processor, prompt the processor to carry out the method as claimed in claim 16.

22. A computer-readable medium, on which the computer program product as claimed in claim 21 is stored.
